(19) United States
(12) Patent Application Publication
(10) Pub. No.: US 2025/0005267 A1
(43) Pub. Date: Jan. 2, 2025

(54) MACHINE LEARNING BASED MODELS FOR LABELLING TEXT DATA

(71) Applicant: PRIVITAR LIMITED, London (GB)

(72) Inventors: Kieron GUINAMARD, London (GB); Filip STEFANIUK, London (GB); Suzanne WELLER, London (GB); Jason MCFALL, London (GB); Hector PAGE, London (GB); Patrick CRIBBIN, London (GB); Sophie MUGRIDGE-WHITE, London (GB); Sergei RIAZANOV, London (GB)

(21) Appl. No.: 18/709,072

(22) PCT Filed: Nov. 10, 2022
(86) PCT No.: PCT/GB2022/052852

§ 371 Date: May 10, 2024

(30) Foreign Application Priority Data
Nov. 10, 2021 (GB) 2116139.3

(51) Int. Cl. G06F 40/169

(52) U.S. Cl. CPC G06F 40/169

(57) ABSTRACT

A computer implemented method for training a machine learning engine to label sensitive information from text data. The method includes the steps of (i) receiving text data and a list of classes that defines the sensitive information to be labelled; (ii) generating a set of synthetic sentences and using the set of synthetic sentences for training the machine learning engine; (iii) predicting labels for entities in a sample of the text data, selecting a subsample of labelled sentences from the sample of text data to provide to an annotator for reviewing, and updating the training data with the user reviewed sentences; and (iv) training the machine learning engine with the updated training data and repeating step (iii) until the performance of the machine learning meets an end-user requirement.

### BACKGROUND OF THE INVENTION

### 1. Field of the Invention

The field of the invention relates to a method of training a model using active learning. In particular, a machine learning model is trained for labeling text data.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Description of the Prior Art

De-identification relates to a set of data privacy techniques that hides or obscures sensitive values in text data by replacing the original values with modified content. Sensitive values within text data first require to be detected and/or labelled.

Recent de-identification techniques have either used manual, rule-based, or machine learning approaches. However, manual processes require significant resources. Rule-based processes rely on word patterns and often have to be fine-tuned for each specific sensitive information and do not take any context of the words into account.

Training a machine learning model typically requires large amounts of labelled data and finding a large amount of data that contains information of a sensitive or identifying nature is not easy. As a consequence, training a machine learning model to de-identify sensitive information is a challenging task.

Data labeling is a critical pre-processing step in developing machine learning models as the quality of the labelled data ensures the performance of the machine learning models. Data labeling may be performed in a number of differ ways. The choice of the labeling approach may depend on a number of parameters such as complexity of the problem, time resources, training data or the type of machine learning process.

One or few-shot learning is a type of machine learning method where the training dataset contains limited information. Such a learning process therefore reduces the need to train a model with many similar examples of the same class. However, one or few-shot learning is often not sufficient to minimise labeling effort and it is still necessary to show the machine learning model the full diversity of examples within a given class.

Active learning refers to a machine learning process that chooses or selects the data from which it learns and involves using a human oracle. As a simplification, a human is asked to supply labels for unlabeled samples that are deemed most valuable in improving the accuracy of the model. However, current active learning models still often lead to unstable or unbalanced models in which for example the training dataset includes classes that are represented by significantly less instances than others.

The present invention addresses the above vulnerabilities and also other problems not described above.

### SUMMARY OF THE INVENTION

An implementation of the invention is a computer implemented method for training a machine learning engine to label sensitive information from text data, the method comprising the steps of:
(i) receiving text data and a list of classes that defines the sensitive information to be labelled;
(ii) generating a set of synthetic sentences and using the set of synthetic sentences for training the machine learning engine;
(iii) predicting labels for entities in a sample of the text data, selecting a subsample of labelled sentences from the sample of text data to provide to an annotator for reviewing, and updating the training data with the user reviewed sentences; and
(iv) training the machine learning engine with the updated training data and repeating step (iii) until the performance of the machine learning meets an end-user requirement.

### Terminology

### Text Sequence Classification

Text Sequence Classification is the terminology used for the Natural Language Processing (NLP) problem also referred to as Named Entity Recognition (NER). Given a sentence of text in a given language, text sequence classification seeks to break the sentence into a list of segments (words, subwords or characters) and apply a class label to each segment.

### Tokeniser

A tokeniser is a standard part of NLP. It is responsible for splitting a sentence (a text sequence) into segments. A naive tokeniser would split a text sequence into either whole words (by splitting on the space character) or into single characters. The choice of tokeniser is important as it impacts the granularity of the predictions the model makes. The methods and systems described below may use any tokeniser approach.

### Segment

The units into which a text sequence is split. This can be one or more words, sub-words or characters. A subword is a part of a word. For example, the word “cannot” could be split into two subwords “can” and “not” (which are themselves also words). A word level tokeniser could leave these as one word, a subword tokeniser will look to split a text sequence into the smaller components.

### Priming

Priming generally refers to a deep learning model that is trained on a small number of examples. Such a model may achieve poor performance as a classifier (with recall/precision somewhere in the region of 10%). However, a priming step is designed to sufficiently enable a confusion sampler to find candidate sentences for annotation and further training.

### Sampling

Sampling is a technique to select a number of representative examples from a population. A number of probability sampling approaches may be used, such as stratified sampling.

### Entity, Class, Label

These terms are all closely related and, depending on our context, will refer to the type of sensitive or identifying information contained within a block of text. They are standard Named Entity Recognition and Machine Learning terms.

### Entity/Class

A class is a generalisation that can be applied to any classification problem. A class is a category of thing that the machine learning model is learning to classify. In the case of image classification this could be “cat” or “dog”, in the case of sensitive data classification models these will be “name” or “social security id”. We use entity when talking about an instance of a class in text sequence classification, we use class when talking about classification in general. As another example, the entity “London” is an instance of the class “city”.

### Label

A label indicates whether an entity (made up of one or more segments) belongs to a class.

### Pool

A set of text sequences from which we can sample and/or annotate.

### Deterministic Finite Automata Regex

A deterministic finite automata is a well-defined concept from computer science. Representing a given regular expression as a deterministic finite automaton allows the patterns matched by the regular expression (i.e. the sequence of characters) to be indexed by an ordinal. It also allows the regular expression to be expressed and analysed as a graphical structure.

### Context

In terms of text sequence processing, the context of a given text segment is the text segments that occur before it and after it.

### Support

Support is the number of actual occurrences of the class in the specified dataset. Imbalanced support in the training data may indicate structural weaknesses in the reported scores of the classifier and could indicate the need for stratified sampling or rebalancing.

### Embedding

A natural language word embedding is responsible for taking a word (which is characters) and mapping it to a numerical vector, which can be processed by an algorithm (often a neural network). In our case the word embeddings operate on the text segments produced by the tokeniser.

### Center (or Centroid)

Given an embedding that will map text segments to a vector, we can map a set of segments all belonging to the same class to a vector space and compute the centre (or centroid) of this set of points.

### Word Span

An entity in a text sequence may consist of more than one text segment. For example, the name entity in “Kieron Guinamard wrote this” consists of two words: “Kieron” and “Guinamard”. A word span is the list of text segments that belong to a given entity.

### Confusion Matrix

In predictive analytics, a confusion matrix (sometimes also called a table of confusion) is a table with rows and columns that reports the predicted class for a corresponding true class. This allows more detailed analysis than simply observing the proportion of correct classifications (accuracy). Accuracy will yield misleading results if the data set is unbalanced; that is, when the numbers of observations in different classes vary greatly.

### BRIEF DESCRIPTION OF THE FIGURES

Aspects of the invention will now be described, by way of example(s), with reference to the following Figures, which each show features of the invention:

FIG. 1 shows tables providing an example sentence, split into words (or tokens) with the class the system is expected to return (1A) and with class predictions (1B).

FIG. 2 shows a diagram that illustrates the active learning cycle.

FIG. 3 shows an example including a sentence with three class predictions.

FIG. 4 shows sentences with the most confused score for each class pair

FIG. 5 shows a confusion matrix for a two-class sequence tagger with classes A and B and the null category.

FIG. 6 shows the confusion matrix with the diagonal information ignored.

FIG. 7 shows the confusion matrix with the total number of errors of any type summed and the error normalised.

FIG. 8 shows the results when the sum of the corresponding cells on either side of the diagonal of the matrix of FIG. 7.

FIG. 9 shows a PCA decomposition of the vector representation for a class representing signoffs at the end of a message

FIG. 10 provides a table with a worked example showing how both methods are combined

FIG. 11 shows a screenshot of a custom UI to support the labeling process.

FIG. 12 shows another example of a screenshot of a custom UI to support the labeling process.

FIG. 13 provides an overview diagram of the system combining regular expressions with neural networks.

### DETAILED DESCRIPTION

A method for training a model using active learning is presented in which an annotator, such as a human annotator or a machine annotator, is asked to supply labels for samples that are most valuable in improving the accuracy of the model. In particular, the machine learning models trained may be named entity recognition models or sequence classifiers for use in de-identification pipelines.

Advantageously, using an active learning process, the volume of samples that require labeling from the human reviewer is reduced. A benefit is that the initial models created are cheaper to produce and less time consuming; a benefit to end-users is that customising models to achieve high accuracy for their own use case requires less effort. When customising models, an end-user only needs to define the classes that need to be identified.

This Detailed Description section is divided into the following sub-sections:
1. High Level Approach;
2. Priming the Active Learning;
3. Sampler;
4. Labelling;
5. Further Applications;
6. Named Entity Recognition (NER) Combined with Neural Networks.

### 1. High Level Approach

The high-level approach uses a batch sampler to select a set of records to be labelled by a human in order to improve performance with client workflows and, more importantly, the models used for sequence classification are best refined on batches of data (as opposed to being updated one record at a time). The batch size may typically be set to a multiple of the number of combinations of pairs of classes the model is learning to classify. Learning one record (or sentence) at a time would be inefficient since the sampling process involves evaluating the model on a pool of unlabelled data, and this would need to be redone every time the model was further trained on the samples.

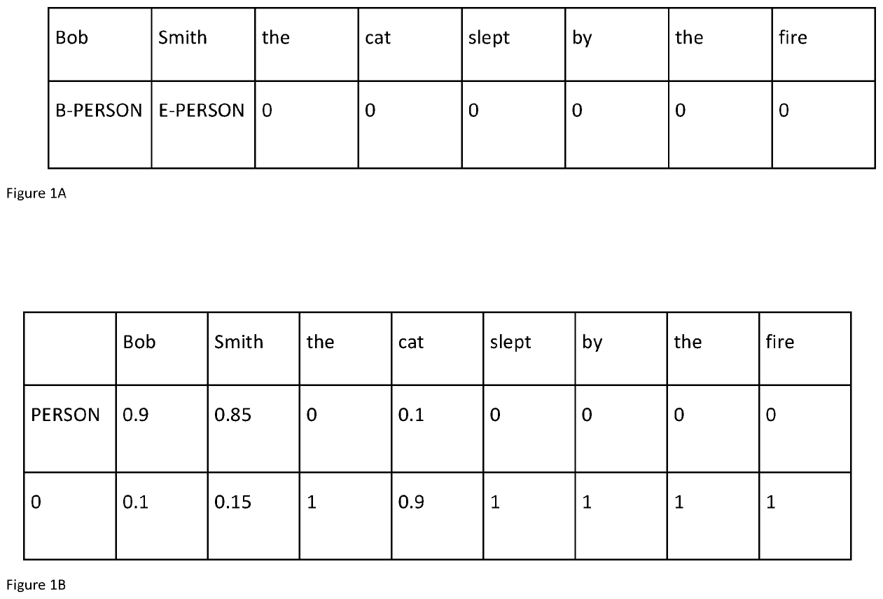

FIG. 1 shows tables providing an example sentence, split into words (or segments)—ready for analysis by a named entity recognition (NER) process. In the second row of the table in FIG. 1A are the labels that the system is expected to return. FIG. 1B provides the predicted confidence score of each entity in the sentence for two classes, ‘person’ and ‘null’.

As an example, “Bob Smith” is a single entity. The correct classes or labels the model is expected to return output are provided. The first half of the entity has been assigned the class label B-PERSON where B indicates it's the start of an entity. The second half has the class label “E-PERSON” to signify the end. Both words are part of a single entity with the class label “PERSON”.

The model is first primed with a handful of records for each class we want to detect; that is the model is refined on a set of data that contain the records. A sampler then looks for unlabeled sentences which it thinks contain entities that match these classes. In particular, the sample identifies sentences where the model cannot distinguish between a pair of classes for a given entity. For example, the sentence “Kieron went to see Paris” contains two entities: “Kieron” and “Paris”. “Kieron” is easily identified as a person, but in this context “Paris” could be the city or a person; the entity here could be confused for one of two different classes. The sampler ranks sentences and then pulls a fixed batch of the highest ranking (e.g. the most confused) from the pool of unlabeled sentences and passes them to a labeling tool. Empirical research has shown that labeling errors cause a significant retardation in the learning rate, so before using the labelled data to refine the model the system may employ several methods to look for possible errors in the labeling and either passes them to a reviewer for correction or drops the sentences from consideration.

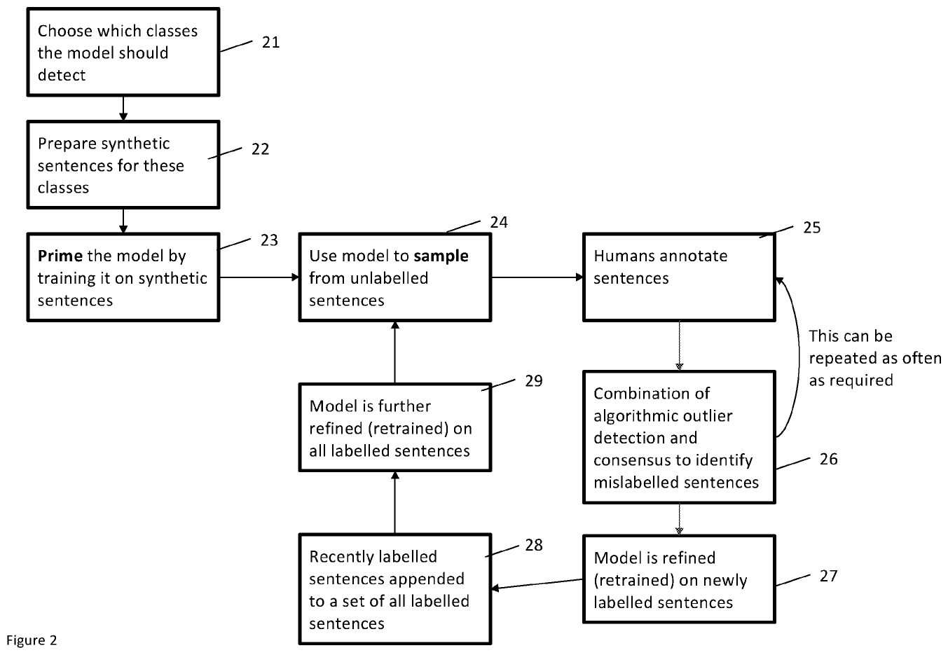

FIG. 2 shows an overview of the main steps of the active learning cycle. A list of classes is first chosen or selected 21, in which the list of classes defines the sensitive information that an end-user wants to label. Based on the chosen list of classes, a set of synthetic sentences (or word sequences) that contains entities belonging to the one or more classes is generated 22. Each sentence then may include one or more example of sensitive information that an end-user wants to label. The set of generated synthetic sentences is then used for priming (this corresponds to an initial training) the machine learning model 23. The synthetic sentences are also automatically labelled by the grammars that generate them. The machine learning model is then used for sampling, in which sentences (or word sequences) within text data are selected 24. As described below, the sampling may be achieved using different approaches. Labels for entities and/or sentences in the sample of the text data are then predicted and provided to an annotator for reviewing 25. The training data is then updated, and the model refined until an end-user requirement is achieved.

A sentence, such as the generated synthetic sentence or the selected sentence from the original text data, generally includes a text sequence of words or segment providing context. It usually includes at least two words or segments and does not necessarily include a subject, a verb or a predicate.

As shown in FIG. 2, an outlier detector may then be used to identify mislabelled sentences 26. The machine learning model may then be refined using the newly labelled and reviewed sentences 27. The recently labelled (and reviewed sentences) are then appended to the training data 28, and the model may further be refined 29. The steps 27 and 29 may be performed using different learning rates. Alternatively, either one or both of steps 27 and 29 may be performed.

### 2. Priming the Active Learning

### 2.1 Handling New Entities

The output layer of a neural network is fixed; this means that the number of different entities our sequence classifier can tag is fixed. It is non-trivial to add additional output classes to an existing network as this may even require altering several of the previous layers of the neural network. To avoid this the initial models supplied have a set number of entities on the output. For the most part these correspond to standard entities that all clients need to detect. Because all possible entities that a user may need to detect cannot be anticipated, a number of the outputs of the network are reserved for unused custom entities.

The custom entities have placeholder names such as “CUST-1”, “CUST-2” etc. If the user of the system needs to add a new entity the system will relabel the next unused custom entity and use that when training the model.

### 2.2 Priming the Active Learning Cycle

In order to get better at detecting new entities (e.g. booking references) the system first needs to know what they look like. Model refinement is where a trained model is further trained using a new different training set, usually with an aim to fine tune it to handle a new task. If the model is refined using a handful of examples of a new entity it will be able to detect more examples in a pool of unlabeled sentences.

For example:
A booking reference looks like: “BK-AR100002323”

We have the following unlabeled sentences:
1. “How long to deliver to SW31AB”
2. “Please make payment to GB29 NWBK 6016 1331 9268 19”
3. “I ordered a new synthesizer keyboard last week, but have no delivery confirmation. Booking reference is BK-AZ100002320”
4. “Booking reference: BK-AR100002323”
5. “My name is Robert Smith”

If the model has already learnt that booking references are alpha numeric then similar patterns will generate predictions for that class label. The closer the pattern in the unlabeled sentence is to the known example, the higher the confidence of the prediction. Initially, when the model has seen very few examples of a new entity the confidence scores it will produce with examples within unlabeled sentences will be low. The more examples it sees the stronger the confidences the model will produce for example words in the sentence that resemble it. If the model had seen no examples previously, the system would be reliant on random sampling for its initial iterations. From empirical results we know that this makes it very slow to learn minority classes. In the above example “BK-AR100002323” has been seen by the model already, when priming. This word will receive a high confidence level prediction for the new class.

The following sections present three methods for priming the active learning process with examples of a new entity.

2.2.1 Priming with Synthetic Sentences

In this section we describe a system which enables customers to define synthetic sentences to prime the active learning process. The technique uses a combination of grammar rules or models, lookup lists and regular expressions. These synthetic sentences may be self-labelled.

The set of synthetic sentences is generated to imitate real data and includes keywords. The keywords are entities that belong to the set of classes that an end-user wants to de-identify. For example, an end-user may want to remove names or cities from a specific text data. The set of generated sentences would then include different examples of names or cities with varied context. Hence the model will be able to learn how to differentiate between names and cities in order to de-identify the text data.

The synthetic sentences are generated based on grammar rules or models to produce a sequence of words or tokens in context.

An example is now described in which the system uses a combination of NLTK (Natural Language Toolkit) grammar files and sensitive term generators. The sensitive term generators can be either regular expressions (for generating pattern-based identifiers such as booking references) or lookup lists (e.g. names of people and places) or a combination of the two (for example generating email addresses).

The NLTK grammar defines a branching structure for all possible sentences. An example grammar is below:

contactme->contact-action me a message at contact|you can contact-action me at contact|this is name ‘,’ contact-action me at contact|at contact|my email is contact
contact-action->‘send’|‘drop’
this->‘this’
is->‘is’
me->‘me’
my->‘my’
a->‘a’
you->‘you’
can->‘can’
at->‘at’|‘on’
email->‘email’|‘email address’|‘e-mail’|‘e-mail address’
message->‘message’|‘note’|‘email’|‘mail’
contact->‘<EMAIL-SPLIT>’|‘<EMAIL-NOSPLIT>’|‘<EML-ACCOUNT>’ ‘<EML-AT>’ ‘<EML-DOMAIN>’
name->‘<FIRSTNAME>’

Words in quotes are terminal nodes, the words not in quotes are nodes which need to be expanded and refer to a line later in the grammar. Words in angled brackets are generators. The sentence generator takes a list of generators and a grammar file and generates all possible sentences according to the grammar (i.e. all possible branches) and a configurable number of calls to the generators. That is, for each distinct sentence n versions of it will be created with different randomly generated substitutions.

For example, if the grammar defines a single sentence: “My name is <NAME>” and the user has requested two versions of each sentence then two sentences would be created by calling the <NAME> generator twice. If the generator is a regular expression generator a new secure random number will be passed to the automata representation of the regex for each version of the sentence requested. This ensures that each version of the sentence gets a randomly selected example of the entity. If the generator is a lookup then a randomly selected value from the lookup list will be chosen each time. The generator also has a class label assigned. If the generator returns multiple words, each word gets labelled as part of the span with the class label. If multiple generators with the same class label are next to each other without a separating unlabeled word the span extends across all of them. In the above grammar ‘<EML-ACCOUNT>’ ‘<EML-AT>’ ‘<EML-DOMAIN>’ are all email generators so the span will start with the account generator and end with the domain generator and all words will receive the same entity label.

### Algorithm Overview

User passes a grammar file, a list of generators (such as regular expressions for booking references, or lookup lists of names) and a count n (to determine how many versions of each sentence)
1. Verify that all generators defined in the grammar have been configured correctly
2. Natural Language Toolkit (NLTK) generates all distinct sentences possible under the supplied grammar
3. For each sentence create n copies of the sentence by calling each generator n times.
4. The result of the above is a sequence of words with class labels, this is converted into a data format, such as a CoNLL-X format (as defined by the annual Conference on Natural Language Learning) or any other labelled data format.

Additionally, typos in the generated sentences may also be included in order to introduce noise in the synthetic data.

Additionally, the sentences may be generated in different languages. The language may also be automatically selected depending on the classes of interest. For example, an end-user may want to identify or classify British and Spanish social security numbers. Hence the sentences may be generated in both English and Spanish. The language may also be selected based on the type of the original text data to be analysed.

Additionally, the system may also select the appropriate grammar rules based on the type of original text data to be analysed. For example, the original text data may include twitter data. The synthetic sentences will therefore be generated in order to imitate real twitter data.

### 2.2.2 Priming Using Vaults

Token vaults may be used for consistent masking, in which masking refers to the process of substituting a sensitive value with a non-sensitive value, i.e a token. However, each time the sensitive value is encountered, the same non-sensitive value will be used to replace it (hence consistent). In vault-based masking, a vault database may store sensitive values as well as the tokens corresponding to the non-sensitive values. The Active Learning (AL) system only requires the original, sensitive values.

The vaults for each entity are used to create single (or few) word labelled sentences. These single words provide a contextless representation of identifiers, however the large size of the vaults means that we can capture a significant diversity of examples. For pattern based identifying information (e.g. booking references) the model will quickly learn the pattern's representation in the character level encodings used by the model.

We now provide an example of algorithm:

CONLL format file is a space separated columnar format consisting of word and label with sentences separated by an empty line. The system creates a JsonL or CONLL file from the vault for use in model priming.

An example CONLL sentence is below E.g.
Kieron B-PER
Guinamard E-PER
says 0
hello 0

For a file full of single values taken from the token vault the system first tokenizes the raw value to split the value into component words. Consider the following example for postal/zip codes.
SW1 B-ZIP
1AA E-ZIP
SW32ZP S-ZIP

If masking results in more than one word (as in the first example above) the system creates a multiword sentence with every word part of the same class. Otherwise each entry in the vault results in a single word sentence.

Each token vault is associated with an entity class. To prime the model for active learning of a given class:
1. Select all vaults associated with the target class
2. Concatenate all values and remove duplicates
3. [optional] Take random sample of size n
4. tokenize all values in the sample to split them into words.
5. Create a CoNLL file as above with one sentence per token vault value.

When all target classes have CONLL files ready for them the model can then be refined for a maximum of fifty epochs on the full set of sentences.

2.2.3 Priming with Vaultless Masking

A technique has been developed for consistently and reversibly masking without using a vault to manage consistency; hence ensuring that a watermark can be directly embedded in the masked data without requiring the use of a vault. Vaultless masking has a number of advantages, especially in distributed deployments where it is not possible to call out to a centralised vault. However, it does not include a vault.

The active learning system can instead be primed using the configuration for the vaultless masking. In order to produce consistent masking, embed watermarks and produce a format that is similar to the input, vaultless masking requires that the user provides a regular expression that describes any constraints on the input. For example, if we needed to mask UK national insurance numbers using the vaultless technique, a regular expression would state that the input consists of two letters followed by 3 pairs of numbers and finally a single letter optionally separated by spaces.

In this case the system will use the regular expression from the vaultless configuration directly and generate a sample of random strings that match. The sample size should be smaller than if using the vault as the patterns are not necessarily representative of the real distribution of values.

### 2.3 Active Learning

The priming methods define starting points for training a machine learning model, such as a sequence tagger. The active learning process will then look for these words in context to see how context affects the label (if at all). We do this by using the model to predict classes for a sample of unlabelled text sequences.

The sequence tagger doesn't output a single class label, but in fact outputs a probability for every single class. For example, a word may be considered 75% likely to be a place name by the model, and 25% likely to be the name of a company. If two entities have similar representations in the word embeddings they will be “confused”, that is the probabilities for each class would often be similar. The “confusion sampler” described below, is able to seek out examples where this occurred, and a human oracle would teach the model how to distinguish them.

If context influences the meaning of words in a text sequence this will be reflected in the predictions made by the model during the sampling process, and thus the samples produced.

### 3. Sampler

### Pairwise Confusion Samplers

This section describes the family of samplers used by the active learning system. The samplers are designed to outperform confidence or entropy samplers in finding “good” examples of sentences (or word sequences) to train and refine the NER model.

Advantageously the pairwise confusion sampler developed provides balanced and smooth learning curves and improves performance of minority classes. This is done by ensuring that each class has an equal representation compared to other classes.

As a comparison, existing samplers struggle with either small class representation or bias. For example, entropy samplers often prioritise examples with high information gain and may achieve poor performance with minority classes. While simpler, confidence samplers may achieve unstable behaviour, precision and recall become anti-correlated.

Pairwise confusion samplers scan sentences for examples where the model predictions for pairs of classes are confused for each other (e.g. currency amount is confused for a date). By focusing on labeling the most confused examples we quickly improve precision as the model learns to assign the correct class to the entities represented by segments of a text sequence.

### Algorithm Outline

1. Tokenize every sentence in the pool (breaking them into a sequence of “words”)
2. Model predicts every sentence in the pool, returning a confidence score for each class on every word
3. Sum the confidence scores for each “part” of a class label (beginning, interior, end or single) for each word
4. For each pair of classes [associated with an entity]
   a. Find the difference between the sum of confidence scores for the two classes
   b. If a confidence score is below a given threshold (say 0.01) set the difference to infinite
5. Rank sentences by smallest confidence difference for each pair of classes over all words (e.g. determine the confusion score as described below)
6. Round robin across each pair to produce a sample of desired size choosing the most confused sentence (as given by the ranking in the previous step) for each class-pair.

Each variant of the sampler has a different way to choose ranking sentences.
a. If no confused sentence is available for a class-pair choose a random sentence ranked at infinite.

The method therefore also includes the step of generating a ‘confusion score’ that indicates the label confusion between two different classes. To generate a confusion score, the method relies on a classifier outputting a confidence score for each possible label or class. For example, consider a classifier that can predict four classes (cat, dog, rabbit, other) and is calibrated to output a confidence (or probability) for each label. If, for a given entity, the confidence score are as follows: cat=0.4, dog=0.1, rabbit=0.4 and other=0.1, then the confusion score between cat and rabbit is the difference in the confidence score between the two labels: 0.4−0.4=0. This is the most confused two labels can be—the classifier was unable to tell if the input was a cat or a rabbit. The higher the absolute confusion score, the less confused the classifier was for the input (with respect to the two classes). Confusion scores may be calculated pair-wise for all possible combinations of a predicted class.

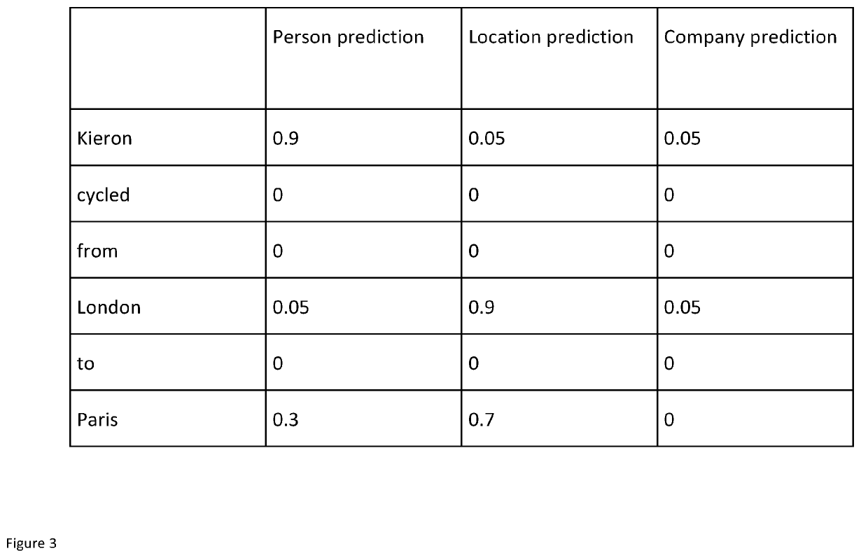

FIG. 3 shows an example including a sentence with three class predictions. “Paris” is somewhat confused for a person. When generating confusion scores for Person/Location, “Paris” is the word with the closest score for both, hence we report this difference as the confusion score for that class pair for this sentence. Predictions for a class that are less than our threshold are ignored, so we do not return the difference between person and company for Paris as the most confused score for Person/Company.

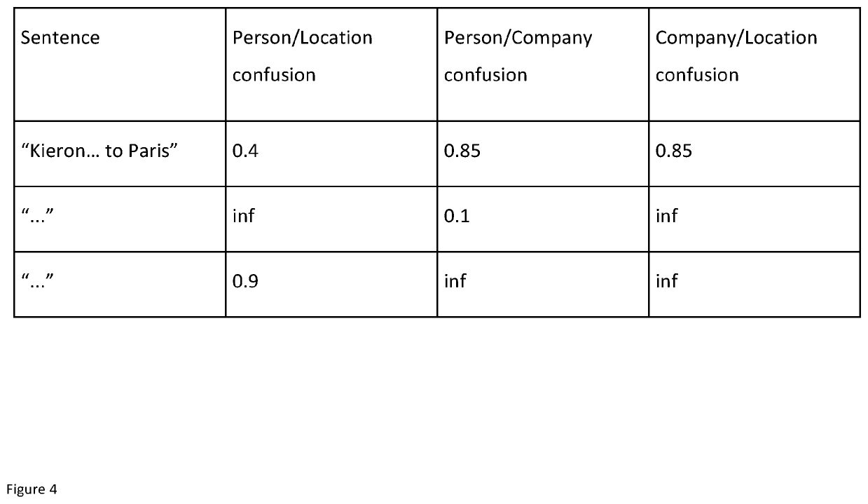

FIG. 4 provides a table that shows sentences with the most confused score for each class pair. “Kieron cycled from London to Paris” has a score of 0.4 for Person/Location, the difference between the person and location predictions for Paris. This is a smaller score than the difference between the persona and location predictions for any other word. If class pairs cannot be compared since there is no prediction for one of the pairs greater than the threshold then a score of infinity will be returned.

When ranking the sentences we may choose the smallest scores first. For Person/Location our London to Paris sentence ranks highest. Having a human verify that Paris is indeed, in this context, referring to the city will allow us to improve the model.

Note that sentences will contain many words and a single sentence can rank highly for several class pairs. There may be several words in a sentence that have strong, unambiguous predictions but will still require labels. The resulting sample should have at minimum, where n=sample size and pc=class-pair count, n/pc words where two classes are confused. However, it will likely contain many more examples of some classes. The benefit of this approach is that minority classes will get more representation than in a random sample. However, this approach does not look to ensure every class is equally weighted.

Further variants for implementing the sampling step are now described.

### Balanced Sampler

A Balanced Sampler may be used that ensures equal representation of each class-pair. As an example, in step six of the algorithm above, we may always choose a sentence when we round robin to a pair.

### Weighted Sampler

A weighted sampler may also be implemented that will not always choose a sentence when we round robin to a class-pair. Instead, for each class-pair, a sentence will be chosen according to a user specified proportion. This allows the sampler to prioritise entity classes of particular interest. For example the model could predict four classes, one class has 99% precision/recall the others are low at 60%—the user could specify a 33% weighting for the poor performing classes and a 0% weighting for the high performing class.

### Confusion-Matrix Weighted Sampler

A weighted sampler requires an end-user to determine which weighting to give each class pair. As the active learning process is iterative we can use the confusion matrix from a previous round of sampling to determine the weight of each class pair. Class-pairs that are often confused may then be given priority over class-pairs that the model can effectively differentiate.

### Algorithm Overview

In order to create a weighted sampler, the system first needs to calculate appropriate weights. For this it uses the confusion matrix generated when the human annotator corrects labels produced by the previous version of the model.

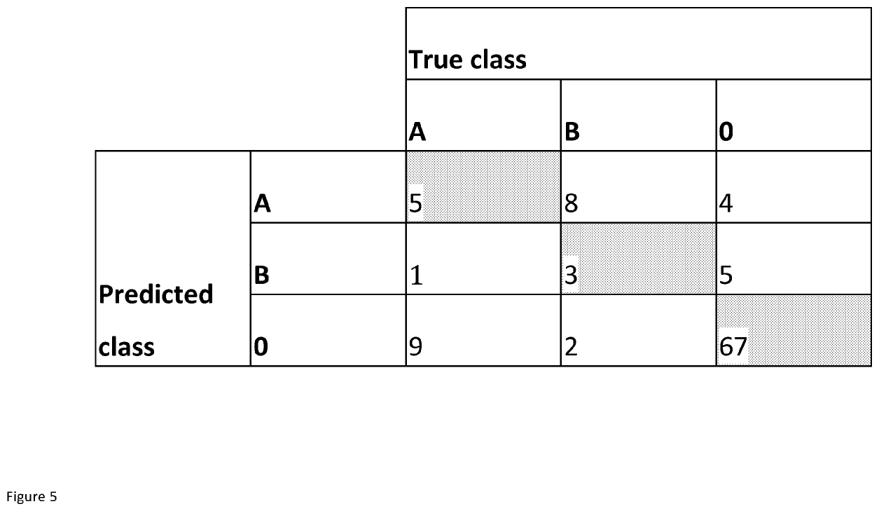

As an example, FIG. 5 provides a confusion matrix for a two-class sequence tagger with classes A and B (e.g. Person or Place) and the null category (for non-identifying words). The diagonal represents true positives ((A,A) and (B,B)) and true negatives (0,0). The white box corresponds to the false negatives, the dotted box the false positives and the box filled with diagonal lines are other types of error (for example where a person is confused for a place). The system produces such a matrix when the human annotator corrects the labels assigned by the sampler.

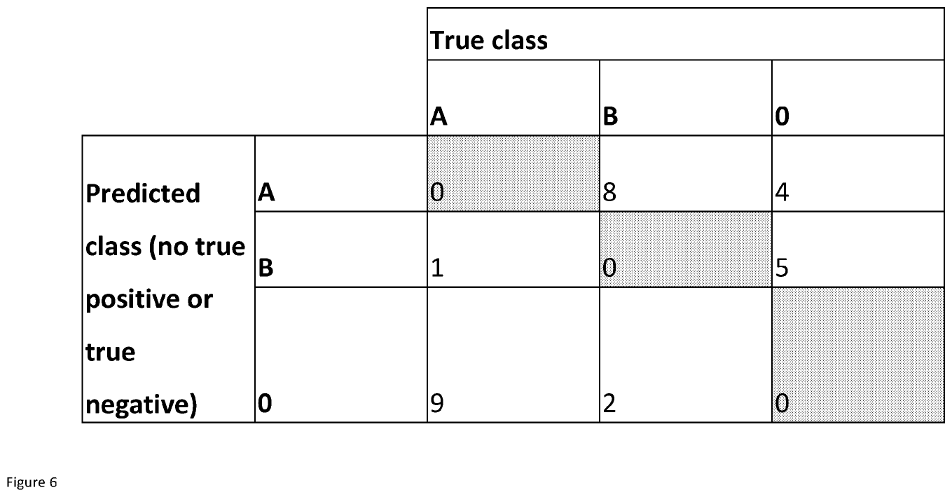

When trying to improve the model we are less interested in where the model is already correct (in grey). The recall of identifying information by the model is improved by reducing errors in (0,A) and (0,B), the precision of the model is improved by reducing the errors in (B,A) and (A,B) (See boxes filled with diagonal lines) and in (A,0) and (B,0) (See boxes filled with dots), as shown in FIG. 5. To determine what sort of sentences the sampler should focus on we ignore the diagonal, as shown in FIG. 6.

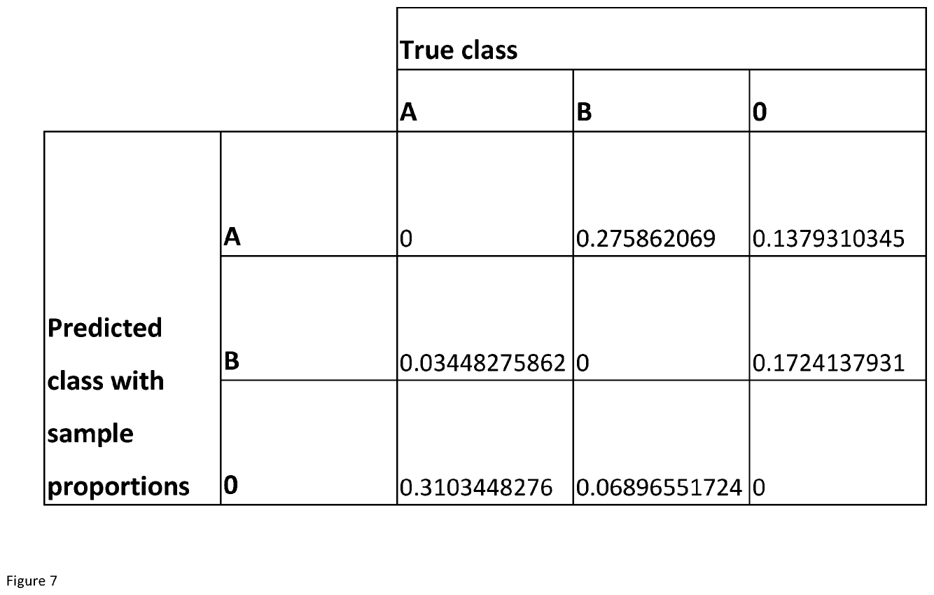

The system then sums the total number of errors of any type, in this case 29. Finally, the system normalises the errors, as shown in FIG. 7.

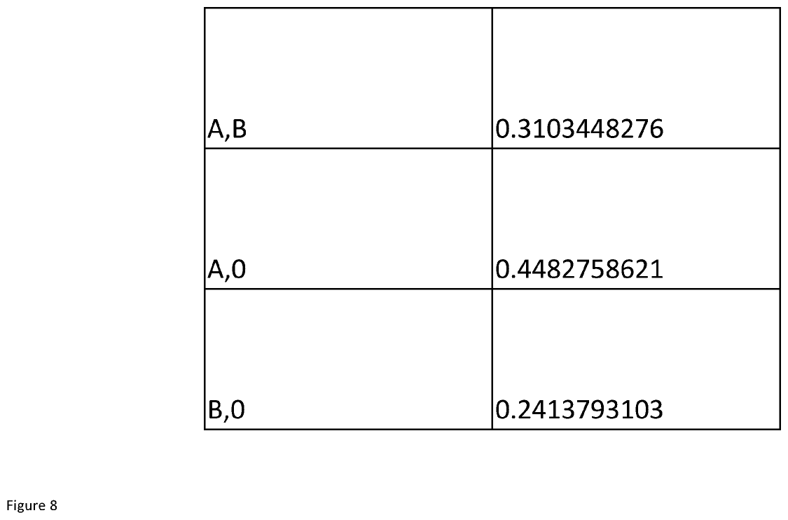

The confusion matrix shows whenever a true example of class A is confused for class B, and how many times a true example of class B is confused with class A. The sampler only cares about the pair (A,B), not the order. Consequently, the system sums the corresponding cells on either side of the diagonal, as shown in FIG. 8.

The sampler will then select a mix of sentences with 31% where class A & B are most confused, 45% where A and 0 are most confused and finally 24% where B and 0 are most confused. When the sampler round robins across the class-pairs it will choose the (A,B) class pair 31% of the time. It does this by populating a list of one hundred booleans with 31 true values and 69 false values at random. For samples of sizes of multiples of 100 this is deterministic, for less than 100 the class pairs chosen may not accurately reflect the desired mix.

The system supports two ways to use these proportions.

1. Use weightings from the previous round (call this M_{N-1}). This may be laggy as the model will have been improved after training and refinement on the newly labelled data. The confusion matrix that we calculate will be for the model prior to the active learning training round, that corresponds to the model used to sample the data. But that model will have been refined on this data, to produce M_{N} which we then want to use to produce another sample.

2. A two-phase sampling approach may also be implemented with a balanced sampler that first generates a small sample with all pairs given equal priority. A human annotator labels this small set. Once the sample of data is annotated, we get a “ground truth” that we can use to compare with the model's predictions. From this we get a proxy to the model's performance (precision/recall and relevant to this case: the confusion matrix). This information is then used to determine the proportions that should comprise a larger set.

The second option may often be the recommended mode and may therefore be set as the default behaviour.

Precision and recall are the two performance metrics an end-user may be interested in. Recall refers to the proportion of examples of a class that the model correctly labels; 100% recall for one class can be obtained by labeling every entity as that class. Precision is the proportion of entities that the model labels as a class that are actually that class. In the previous example, where we got 100 recall we would have had very poor precision. Ideally both precision and recall may need to be improved. Advangeously, the confusion sampler is configured to simultaneously improve precision and recall.

High recall but low precision is not so useful when the model is used for de-identification as the low precision means that we end up removing more information than we want to. However, when training the model using active learning, it does help if the model is able to flag a larger number of examples as being possibly of a given class.

In the converse case, when recall is very low the sampler pulls a set closer to a random sample. For minority classes it's unlikely that this contains many examples of that class.

If the user only wishes to improve recall, a desired proportion of sentences can be set by only considering the false negatives highlighted in grey (see FIG. 6), i.e. where the model predicted 0 (non-identifying) instead of the correct class. This may be the preferred option when the model has only just started to learn new classes.

False negatives may be determined when comparing performance of the model with ground truth information.

A false negative (for a class) refers to the case where the model predicted anything but that class. If we want to boost the precision of a given task, then we should look at all cases where the class was confused with the model giving a different prediction. In a non-balanced case, the system weights the sample using the confusion matrix (we pull more examples for pairs of classes where the model is confused instead of pairs for which the model does not get confused). For example, if the model often confuses person with location, but never confuses person with phone number: the sampler can be weighted to pull many examples of person/location confusion but none of person/phone-number.

As another example, if we're only interested in improving recall, the model may be configured to look just at cases in which a person is confused with the null category. We won't improve precision much (the model may continue to mistake person/location), but recall will improve for cases in which a person was previously incorrectly predicted as null.

Therefore, the model may be trained, and the training steps are iterated until a particular required user-defined performance is achieved. User-defined performance may include one or more of the following: predefined percentage of recall, precision level, particular class performance or confusion score in between classes. Alternatively, the model may be trained until a predefined number of iterations has been reached.

### 4. Labelling

Poor quality labels cause problems for model training. Incorrectly labelled data confuses the model and requires significant amounts of correctly labelled data to unlearn potentially contradictory information.

### 4.1 Algorithmic Detection of Labelling Errors

This section describes a method to detect potential labeling errors and alert a human labeller, allowing them to verify or correct the applied labels. Clustering the labels in the embedding space allows us to identify outliers that may not belong to the class.

The word embeddings at the front of the named entity recognition model are responsible for mapping words within a sentence to numbers (vectors) that can be processed by the model. The rest of the model is a bi-directional long-term short-term network and allows us to consider the context the words have within a sentence. Different embeddings have different properties; basic embeddings only map known words to vectors (e.g. Word2Vec), more complex embeddings operate at a character level and are able to detect subwords, and finally the most full featured word embeddings give different vectors for words depending on the context in which they are found (the words on either side).

As an example, consider the one-hot encoded word embedding for the following vocabulary: {“cat”, “dog”, “fish”, “badger”, “alpaca”, out_of_vocabulary}. Every word except for cat, dog, fish, badger and alpaca will be mapped to out_of_vocabulary; those words which are not are mapped to that particular word. When mapping words within a sentence to their point in the embedding space we get the following:
Cat->(1,0,0,0,0,0)
Dog->(0,1,0,0,0,0)
Rabbit->(0,0,0,0,0,1)
Frog->(0,0,0,0,0,1)

Every word is mapped to a six-dimension vector. Words, such as “Rabbit” and “Frog”, not in the vocabulary are mapped to the same vector. In practice one-hot encoded embeddings are never used; for any useful vocabulary size the dimensionality of the vectors gets unusable quickly. Most modern embeddings from Word2Vec through to cutting edge are learnt representations that are more compact. How they are generated is beyond the scope of this document.

Stacked embeddings are when multiple embeddings are concatenated (Akbik, Alan, Duncan Blythe, and Roland Vollgraf. “Contextual string embeddings for sequence labeling.” In Proceedings of the 27th international conference on computational linguistics, pp. 1638-1649. 2018.) The resulting vectors for each word consist of the representation in one embedding concatenated with the representation in the other. For example, consider the additional one hot embedding for the vocabulary {“Rabbit”, “Frog”, out_of_vocabulary}. In the concatenated embedding of this and our previous example we get the following representation for the word rabbit: (0,0,0,0,0,1,1,0,0). This is a 9 dimension vector: the sixth dimension has value 1 as “Rabbit” is not in the first vocabulary, the seventh dimension has value 1 as “rabbit” is the first word in the second vocabulary. “Cat” has the representation (1,0,0,0,0,0,0,0,1) in the concatenated embedding, the first six dimensions matching its representation in the first embedding, the last dimension has value 1 as “Cat” is not in the second embeddings vocabulary. As an example, for english outlier detection the system uses both the flair news forward and news backward contextual embeddings, the dimension of the stacked embeddings this produces is 4096.

The Flair framework, built on top of Pytorch, makes it easy to calculate the embeddings for each word in a sentence. Sentences can be passed one-by-one to an embed ( ) call on the stacked embeddings.

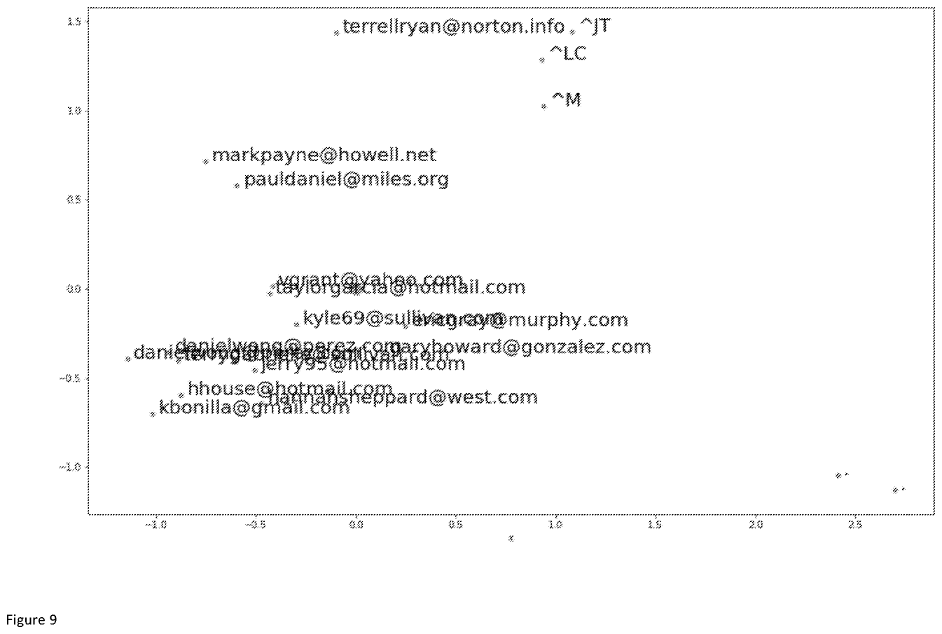

FIG. 9 shows a PCA decomposition (to 2 dimensions) of the word vectors for example entities labelled as emails.

In order to create a cluster for a class of entities we need a set of sentences containing the entity within context. We'll call this the support. This can be generated from all known correct examples of the class from previous labeling rounds or a small subset. Once we have a support cluster the system finds the centre of this cluster in the vector space given by mapping each word (in context) using a concatenation of word embeddings and calculating the mean of all of the resulting vectors. Given a large enough support, the centre of the cluster will be representative of the entire class; words that map close to the centre will likely be members of the class, words that are far away will likely be from a different class.

### Handling Word Spans

Sequence prediction is different to single classification models. Instead of returning a single class for the entire sentence, our models return “spans” that cover all words within the sentence that belong to a single entity. For example:

Kieron Guinamard rode to Cambridge by bicycle at the weekend
B-PER E-PER 0 0 S-LOC 0 0 0 0 0

The first two words in the sentence form a span and represent a single entity of class “person”. The system needs to consider the whole span. For simplicity, the system should take the mean of the embedding vectors for both words to get a vector for the span as a whole.

### False Positives and False Negatives

For each labelled word in a sentence, we can calculate the distance in vector space to the centre of the cluster. The implementation uses the cosine distance. Other metrics include euclidean distance, manhattan distance and hamming distance; the appropriate metric to use depends on how similar the sentences are to each other. Cosine distance was used in the prototype implementation as sentences could be of varying length. The system should ensure that the metric is configurable. If a word is far from the centre, it is likely to be a false positive. We can rank all labelled words and choose to double check the percentage threshold furthest from the centre of the cluster.

However, this only finds cases where a label has been incorrectly assigned to a word. It will not catch cases where the human labeller failed to assign the class label. For this we need to determine false negatives. For every word that was not given the class label we also calculate distance to the cluster centre. We consider those close to the cluster centre for double checking.

### Algorithm Overview

For all words in all sentences:

Calculating the cluster centre from the support:
For all sentences in support set:
   Tokenize the sentence into words
   Assign spans to words
   Embed sentences in stacked embedding
For each entity class.
   Select all spans for the class and return the embedding vectors.
      1. If a multi word span find arithmetic mean of the embedding vectors for all words in the span
      2. Otherwise return the vector for the word in the span
Calculate the arithmetic mean of all spans for the class. This is the centre of the cluster for this class in the embedding space.

Each sentence in the pool of labelled data is allocated an id, and against each id we store a double check count to indicate how many times the sentence has been double checked.

For all classes the model can predict:
1 Calculate the distance between the word-span in embedding space and the centre of the class cluster
2. Rank all word-spans by distance to cluster
3. For each class cluster
   a. For word-span with same class label as the cluster: mark top n % furthest from cluster centre as requiring re-labeling (false positives)
   b. Else, for word-span with different class label: Mark top n % closest to cluster centre as requiring re-labeling (false negatives)
4. Upload all marked sentences not already double checked to the labeling tool for double checking along with their id in the master training set. The id of the sentence is checked against a master list that indicates which sentences have already been double checked.
5. Humans re-label the selected sentences
6. Relabeled sentences are merged back into the master pool of labelled data and the checked status for all of these sentences is updated.

### Recalculating the Centre of the Cluster

As more examples of the class are found a better representative cluster can be calculated. As more correctly labelled data is assembled the cluster centre is re-calculated. This process is the same as calculating the original cluster centre; there is no limit to the size of the support used (i.e. the number of examples considered)

### Complex Classes

Some classes may be a compound of distinct sub-classes. Analysis of the clusters by projecting them into a lower dimensional representation (e.g. 2d) may demonstrate possibilities for splitting the class. For example: reference numbers may consist of both booking references and shipping references each with distinct prefixes. These will form two distinct clusters.

For example, FIG. 9 shows a PCA decomposition of the vector representation for a class representing signoffs at the end of a message. For the most part these are all emails, but some are initials prefixed with a \hat{ }symbol. The initials form a distinct subgroup and the two groups can be turned into separate classes (e.g. email and initials).

The system supports bulk relabeling by allowing the user to select entities from the 2d decomposition with a rectangle or lasso. Whilst the context is missing in many cases this is an effective way to assign labels when the total number of entities for a class is small.

### 4.2 Label Consensus

If more than one human annotator has provided labels for a word we can use the degree of consensus to inform how likely the label is to be correct. If all human labelers agree then the word label is more likely to be correct than if none of the human labelers agree. The system offers a number of methods to use this information to reduce the amount of time required to double check the accuracy of the human provided labels.

A single pass by many human labelers can be done as cheaply as multiple passes by a smaller number of labellers—but much more quickly. Where they all agree we can have high confidence that the assigned label is correct. Where humans do not agree it can point to either human error, a contentious word (for example uncertainty as to whether it is the name of a brand or the name of a person or organisation). Finally, some sentences may be garbage where no sensible labels exist.

As an example, the degree of consensus may refer to the ratio of majority prediction to total predictions. If four people label a word as “person”, the fifth labels it as “location” and the sixth and final annotator labels it as “null” then the degree of consensus is 4/6 (expressed as a percentage this is 67%).

### Simple Consensus Only

The simplest form of the algorithm involves only choosing sentences where all labelers agree on all labels. This is best employed when a small number of manual labelers are available (less than or equal to 4).
1. Pass over the dataset, for each sentence
   a. Record a boolean next to each sentence to indicate whether all labelers agreed on all labels (true if all labelers assigned the same label to each word)
2. Filter out any sentence where the boolean is set to false.

When a larger number of human labelers are available the labelled sentences are likely to include examples where not all human labelers agree but most do. For example, if ¾ human labelers agree on a label that ¾ majority can be used to define the correct label. This is preferable as it avoids the odd data entry mistake resulting in a dropped sentence. In cases where only ½ to ¾ labelers agree the sentences can be sent for double checking. The system takes these thresholds as parameters and the user can vary them based on the complexity or quality of the raw data (poor quality raw data may require a higher threshold of agreement).

The system includes a UI for labeling sentences. This UI highlights which words in a sentence had contentious labels.

Finally, this can be combined with automated outlier detection. Outliers that all human labelers agree on do not need double checking. This allows re-labeling to focus on outliers where humans disagree. If the level of human disagreement is extremely high it may indicate a garbage sentence. These should be removed from the training data. High level of disagreement will also indicate that the class boundaries are unclear to humans; in this case labeling guidelines need to be revisited so the system escalates these sentences to the admin responsible for labeling guidelines.

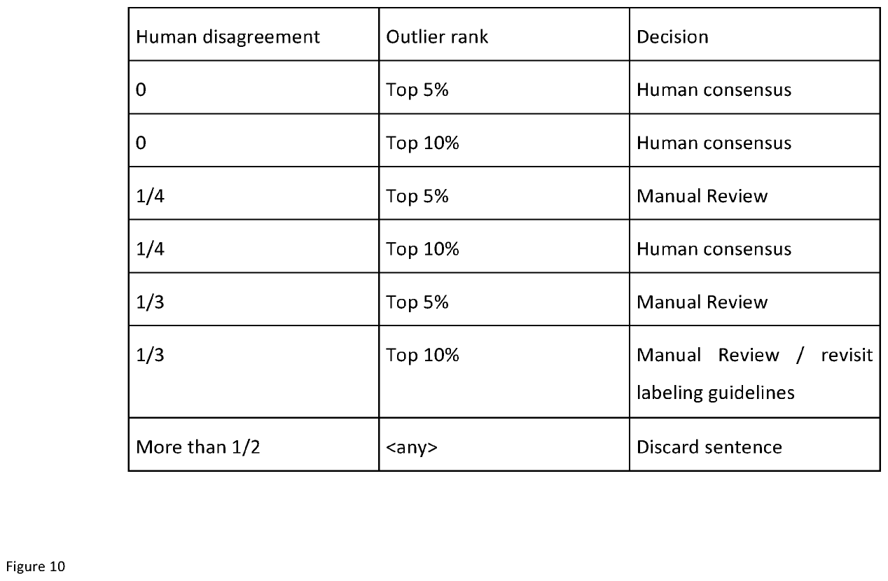

FIG. 10 provides a table with a worked example showing how both methods (human disagreement and outlier rank) are combined (the percentages are arbitrary in this example and can be configured by the user of the system).

The label shortcuts used by the system are randomised across all human labelers to avoid labeling errors that result from poor UX being the same for all labelers.

### 4.2 Labelling User Interface (UI)

A custom UI is required to support the labeling process. Within the UI a user must be able to define a new entity class and document labeling guidelines.

Labellers can log in and see their allocated sample.

When providing initial labels the labels predicted by the model used to select the sample will be present and the user requested to confirm or change each label in turn. Keyboard shortcuts should be available for each action.

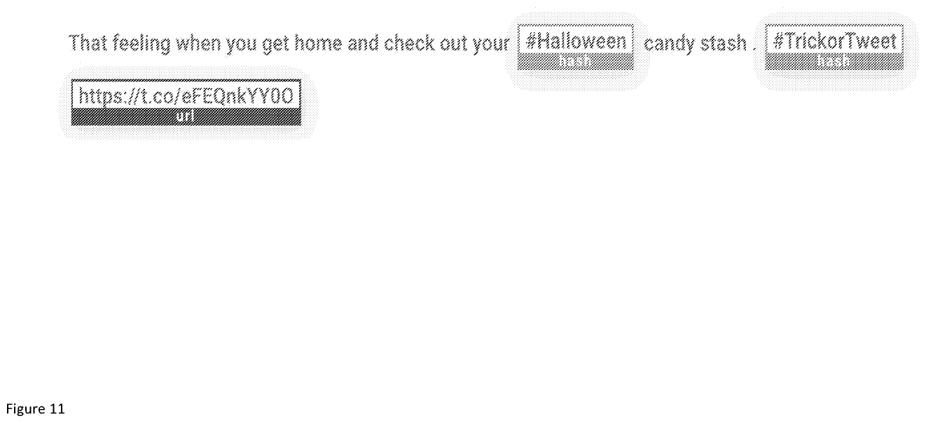

FIG. 11 shows a screenshot of a custom UI to support the labeling process. As shown, the shortcuts h (for hashtag) and a (for url) are natural choices. However, this does not scale beyond a few labels. Phone number, person and postal code would all compete for the shortcut p. Instead the system allocates random shortcuts to each user. This increases the learning curve, but reduces the likelihood that a systematic error affects all labels (for example, all labelers mislabeling phone numbers as postal codes).

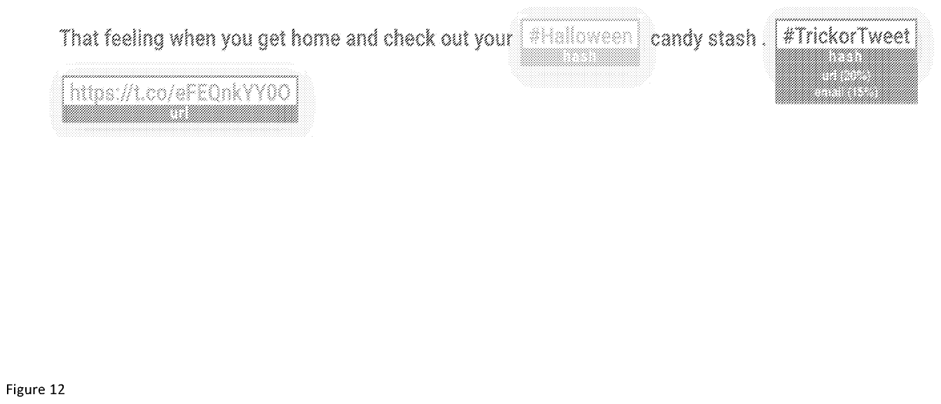

When correcting labels only those labels requiring correction will be highlighted although the other labels will be present with increased opacity (and if an error is spotted there they can also be edited). The contentious label can be clicked on and the user will be presented with: their previous label, and the top three manually assigned labels with the associated proportion of labelers indicated next to each label, as shown in FIG. 12. As before the labeling guidelines will show when a candidate label is chosen in a panel to the side.

### 5. Further Applications

### Sensitive Information

Sensitive information relates to any information about a person, company, or other entity whose privacy must be preserved. Sensitive information may include identifiers, such as social security number or passport number, as well as quasi-identifiers, such as gender, age, height, weight, location data, travel data, financial data or medical data. Sensitive information may also include private communication data.

Most generally, the methods and systems may be applied to label any information that can be defined as belonging to a class.

### Unstructured or Structured Text Data

The examples provided above focus on classifying identifiers or quasi-identifiers from unstructured data. However, the methods and systems presented may be generalised to apply to any type of data, including structured data, unstructured data or a combination of structured and unstructured data. As an example, the methods could be used to analyse structured data, such as a table of payment to flag fraudulent or non fraudulent payment. In particular, the use case applications provide an active learning process that outputs a confidence score for each label.

Text data may include any unstructured files, for example, log files, chat/email messages, call records or contracts. It may also include any internet or web-browsing related information.

Text data may also include streaming data from one or more streaming sources, such as micro-batch data or event streaming data.

Text data may also include any text data within image or video-based data.

The previous sections describe how the active learning process is applied to our natural language models used to de-identify text data. The process described may also be generalised beyond the de-identification of text data. For example, it can also be used in the following areas:

### Classifying Data

Understanding what risks reside in a datasets requires understanding what sort of information is in a dataset. Often this is a manual process which takes significant effort from data owners. Automated classification algorithms and the same active learning process can be used to train and refine models to classify a dataset. Although this isn't a sequence classification problem it is similar enough that the same approach can be taken as for text classification.

### Automating Policy Construction

The privacy protection given to a dataset is described by a policy: a set of rules indicating how a dataset should be transformed to make it safer. This can be time consuming.

Elements of the active learning process can be adapted so that only the most uncertain parts of the policy need to be surfaced to users. Each time the process sees more data it gets better at constructing the policy saving users' time. Unlike the data classification use case this will not make use of the batch sampling process previously described.

6. NER Combined with Neural Networks

Regular expressions (Regex) are a common technique in NLP. Regex can be used to locate sensitive information, including passport numbers, credit card numbers, social security numbers. Identifiers or quasi-identifiers are often generated to be consistent with a regular expression.

Unfortunately regular expressions may not always generalise well: regular expressions need to be defined for all synonyms of an entity. As an example: the date, 5th December 1980, can be represented in a number of different ways. 5/12/1980, 12/5/1980 will both be picked up by the same regex. 5/12/1980 may not, 5-12-1980 has a different separator. “5th December 1980” would not be picked up by most regexes for matching dates, As another example, Krampusnacht eve however would not be picked up by any regex—it would require a lookup list.

As a result, regex and lookup are often defined as brittle. Trying to catch all possible formats is akin to playing whack-a-mole.

Modern neural networks based on either word embeddings+Bidirectional LSTMs or transformers generalise a lot better. However, they are only as powerful as the large amounts of unlabelled data that they are trained on.

A transformer is a deep learning model that adopts the mechanism of self-attention, differentially weighting the significance of each part of the input data. It is used primarily in the fields of natural language processing (NLP) and computer vision (CV). Like recurrent neural networks (RNNs), transformers are designed to process sequential input data, such as natural language, with applications towards tasks such as translation and text summarization. However, unlike RNNs, transformers process the entire input all at once. The attention mechanism provides context for any position in the input sequence. For example, if the input data is a natural language sentence, the transformer does not have to process one word at a time. This allows for more parallelization than RNNs and therefore reduces training times.

This poses a problem for us where sensitive and identifying information cannot, for the most part, form part of training data. There are no huge corpora of text data that contain sensitive and identifying data. For this reason, networks built using transformers or embeddings do not have high performance on more structured identifiers. Worse, once the data is tokenized, for example by SpaCy or BERT, standard regexes no longer apply.

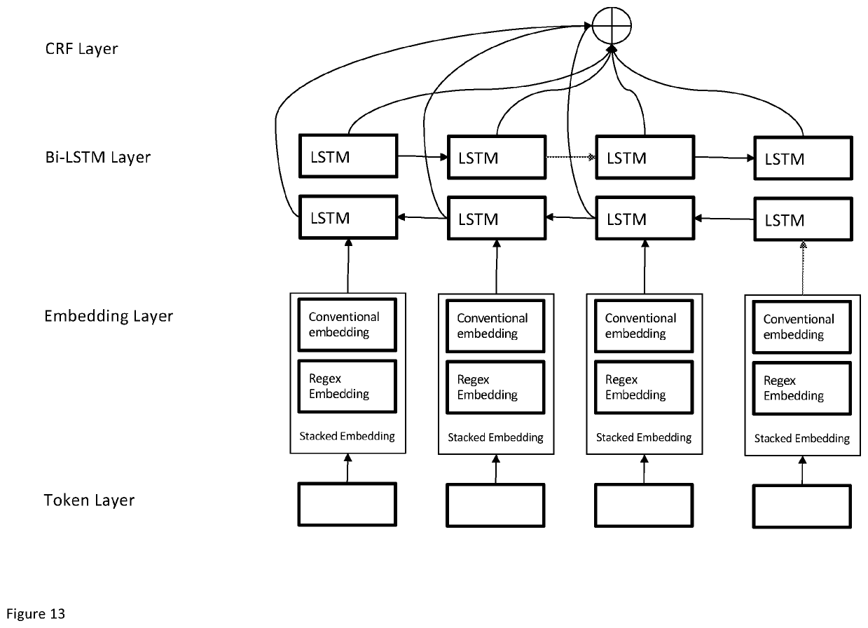

A method is then presented in which sensitive and/or identifying information are represented by regular expressions into a neural network. An overview diagram of the system combining regular expressions with neural networks is shown in FIG. 13.

In addition to the word embedding, a parallel arm of the network implements a regular expression embedding. This is a one-hot encoding where, if a token matches the embedding, the vector is set to “1” at that point and “0” otherwise.

Unfortunately the tokeniser can split words and identifiers into component parts and removes whitespace. For example:
kieron.guinamard@privitar.com becomes “kieron”, “.”, “guinamard”, “@”, “privitar”, “.”, “com”
15-04-01 becomes “15”, “-”, “04”, “-”, “01”

With sub-words that were part of a larger word retaining an indicator in the tokenized sentence to show that it belongs to the same word as the following word.

The key then, is taking a large number of regular expressions and expressing them as subexpressions (sub-regexes). We do this by building the automata graph for each regular expression and then re-expressing them as combinations of common sub-graphs (if the subgraph would have matched a term that is not end-of-word we amend the sub-regex to match the continuation character as well). It is possible that a sub-regex is too small, so we can (optionally) also apply the tokenizer to representative samples generated by the regexes and test that the sub-regexes fully match whole subwords.

We can now construct a new regex embedding that contains subregexes that match subwords generated by the tokeniser for more structured identifiers.

### Appendix—Summary of Key Features

The key features are now generalised. We list also various optional sub-features for each feature. Note that any feature can be combined with any one or more sub-features (whether attributed to that feature or not) and every sub-feature can be combined with one or more other sub-features.

### Feature 1. Entire Workflow

A method for training a machine learning model or engine to label sensitive information from text data is provided. First the machine learning model is primed using a set of generated synthetic or artificial sentences or text sequences. A balanced sampler is then implemented that predicts labels for entities within a sample of the original text data and that determines a confidence score for each label that has been predicted. A subsample of pre-labelled entities that has been predicted is then sent to an annotator, such as a human annotator or a machine annotator. The annotator then selects the most appropriate label for the pre-labelled entities. Advantageously, the labeling performance of all classes improves at the same rate through an iterative process.

In particular, the machine learning engine may then be used to automatically de-identify the labelled sensitive data. Hence the original text data to be analysed (i.e de-identify with the final trained model or engine) may also form the basis for the training data used to improve the machine learning engine. The original text data that the active learning process samples from is then used to further train the model.

We can generalise as:

A computer implemented method for training a machine learning engine to label sensitive information from text data, the method comprising:
(i) receiving text data and a list of classes that defines the sensitive information to be labelled;
(ii) generating a set of synthetic sentences that contains entities belonging to the one or more classes and using the set of generated sentences for training the machine learning engine;
(iii) predicting labels for entities in a sample of the text data, selecting labelled sentences from the sample of text data to provide to an annotator for reviewing, and updating the training data with the user reviewed sentences,
(iv) training the machine learning engine with the updated training data and repeating step (iii) until the performance of the machine learning meets an end-user requirement.

Optional features:
The selected labelled sentences in step (iii) form a subsample of the original sample of text data.
Received text data refers to sequences of words or sequences of characters.
Received text data includes unstructured text data, structured text data or a combination of unstructured and structured text data.
Received text data doesn't include any annotations or labels.
Method includes the step of providing a confidence score for each labelled sentence or entity, and in which the confidence score is a value that corresponds to the probability or likelihood that the entity belongs to one or more classes.
Each entity may be mapped to multiple labels, with a confidence score being associated with each label that has been mapped to the entity.
The method includes the step of outputting the annotated text data.
End-user requirement includes predefined number of iterations reached.
End-user requirement includes confidence score reached for labelled sentences.
End-user requirement include one or more of the following: predefined percentage of recall, precision level, particular class performance or particular confusion score in between classes.
Sample of text data is selected based on a probability sampling approach, such as stratified sampling approach.
The sensitive information includes identifying data such as social security number or passport number.
The sensitive information includes quasi-identifying data such as gender, age, weight, height, location data, travel data, financial data or medical data.
The sensitive information includes private communication data.
The sensitive information includes any information that can be defined as belonging to a class.

### Feature 2. Synthetic Sentence Generation

Each sentence is synthetically or artificially generated as an approximation to a real sentence by selecting each successive word or entity based on a set of predefined classes that an end-user wishes to identify. The sentences include one or more entities belonging to a set of predefined classes. The entities may be generated based on a regular expression which gives an ordered list of possible output tokens (for generating pattern based identifiers), or using lookup lists (e.g names of people or place) or using a combination of the two (e.g email addresses). The sentences are generated based on grammar rules or models to produce a sequence of words or tokens in context. Different sentences for a specific entity may then be provided with varied context. Hence the model will learn how to differentiate classes, even if the classes have a similar format, such as phone numbers and credit card numbers. Advantageously, the set of artificial sentences may be selected such that the model is only presented with a varied number of examples without any bias in the distribution of the generated set of synthetic data. The synthetic data may also include noise which may be introduced by including typos in the sentences for example.

We can generalise as:

A computer implemented method for training a machine learning engine to label sensitive information from text data, the method comprising:
(i) receiving text data and a list of classes that defines the sensitive information to be labelled;
(ii) generating a set of synthetic sentences that contains entities belonging to the one or more classes and using the set of generated sentences for training the machine learning engine, in which the synthetic sentences are generated based on grammar rules or models to produce a sequence of words or tokens in context;
(iii) predicting labels for entities in a sample of the text data, selecting labelled sentences from the sample of text data to provide to an annotator for reviewing, and updating the training data with the user reviewed sentences,
(iv) training the machine learning engine with the updated training data and repeating step (iii) until the performance of the machine learning meets an end-user requirement.

Optional features:
The entities are generated based on a regular expression and/or using lookup lists.
Method includes the step of introducing noise in the synthetic sentences, such as generating typos.
Language of the synthetic sentences is automatically selected based on analysing the received text data.
Grammar rules are automatically selected based on analysing the received text data.

### Feature 3. Confusion Sampler

Existing samplers struggle with either small class representation or bias certain entities. A balance confusion sampler is provided that improves performance of all types or classes of entities, even if some classes have very little representation in the original text data. As an example, the text data may be social media data such as twitter data and may include a lot of examples of name or twitter handle, and very little example of postcode. However the sampler provided ensures that each class has an equal representation compared to other classes. Each entity that has been identified within the original text data is mapped to one or more labels, and each label is linked to a confidence score that corresponds to the probability or likelihood that the entity belongs to the class associated with the label. When an entity has a similar probability of belonging to two or more classes, the entity is reviewed by the annotator and the annotator corrects the label if needed.

We can generalise as:

A computer implemented method for training a machine learning engine to label sensitive information from text data, the method comprising:
(i) receiving text data and a list of classes that defines the sensitive information to be labelled;
(ii) generating a set of synthetic sentences that contains entities belonging to the one or more classes and using the set of generated sentences for training the machine learning engine, in which the synthetic sentences are generated based on grammar rules or models to produce a sequence of words or tokens in context;
(iii) predicting labels for entities in a sample of the text data, selecting labelled sentences to provide to an annotator for reviewing, and updating the training data with the user reviewed sentences,
(iv) generating a confusion matrix that represents a comparison of the predicted labels with the labels reviewed by the annotator; and
(v) training the machine learning engine with the updated training data and repeating step (iii) until the performance of the machine learning meets an end-user requirement, and in which the selection of labelled sentences is based on the generated confusion matrix.

Optional features:
The confusion score is a value that indicates how close the prediction for a given class is to another class.
The confusion score is determined for each sentence, based on the confusion score determined for each entity in a sentence.
ML engine ranks each sentence based on an analysis of the confusion matrix and/or the confusion scores.
In which each class or class pair is assigned a weight.
The confusion matrix is updated for each iteration of step (iii).
The confusion scores are updated for each iteration of step (iii).

### Feature 4. Weighted Sampler

A computer implemented method for training a machine learning engine to label sensitive information from text data, the method comprising:
(i) receiving text data and a list of classes that defines the sensitive information to be labelled, in which each class or class pair is assigned a weight;
(ii) generating a set of synthetic sentences that contains entities belonging to the one or more classes and using the set of synthetic sentences for training the machine learning engine, in which the synthetic sentences are generated based on grammar rules or models to produce a sequence of words or tokens in context;
(iii) predicting labels for entities in a sample of the text data, and selecting labelled sentences to provide to an annotator for reviewing based on the assigned weights, and updating the training data with the user reviewed sentences,
(Iv) training the machine learning engine with the updated training data and repeating step (iii) until the performance of the machine learning meets an end-user requirement.

Optional features:
Weights are assigned by an end-user.
Weights are automatically assigned.
Weights are updated at each iteration of step (iii).
The method includes the step of comparing the performance of the machine learning engine with ground truth information and selecting the sample of text data based on the comparison results.
The method includes the step of generating a confusion matrix that represents a comparison of the predicted labels with the labels reviewed by the annotator. This indicates where, on average, the model is making the most mistakes. It is then used to weight which sentences are chosen by the sampler (in a subsequent round (iii) of sampling) in favour of sentences where the model was making more errors.
The weights are updated based on the generated confusion matrix and/or the confusion scores.

### Feature 5. Consensus for Correct Labeling

A computer implemented method for training a machine learning engine to label sensitive information from text data, the method comprising:
(i) receiving text data and a list of classes that defines the sensitive information to be labelled;
(ii) generating a set of synthetic sentences that contains entities belonging to the one or more classes and using the set of synthetic sentences for training the machine learning engine;
(iii) predicting labels for entities in a sample of the text data, selecting labelled sentences from the sample of text data to provide to multiple annotators for reviewing, and updating the training data with the user reviewed sentences,
(iv) training the machine learning engine with the updated training data and repeating step (iii) until the performance of the machine learning meets an end-user requirement.

Optional features:
The labels are corrected or validated only when the multiple annotators reach a pre-defined consensus percentage.

### Feature 6. Outlier Detection

Once annotators have gone through one round of labeling, the ML process uses an outlier predictor to analyse the label/entities projected in the embedded space. As an example, a twitter handle and an email will look similar in the embedding space.

A computer implemented method for training a machine learning engine to label sensitive information from text data, the method comprising:
(i) receiving text data and a list of classes that defines the sensitive information to be labelled;
(ii) generating a set of synthetic sentences that contains entities belonging to the one or more classes and using the set of generated sentences for training the machine learning engine;
(iii) predicting labels for entities in a sample of the text data, selecting labelled sentences from the sample of text data to provide to an annotator for reviewing, and updating the training data with the user reviewed sentences,
(iv) training the machine learning engine with the updated training data and repeating step (iii) until the performance of the machine learning meets an end-user requirement;
and in which an outlier detector is then used between step (iii) and (iv) to detect outliers in the reviewed sentences.

Optional features:
Method includes the step of representing each entity into a vector space.
Method includes the step of determining a support for each class, in which the support refers to the set of labelled sentences that contain that class.
Method includes the step of representing the support for each class into a vector space and determining a centre within the vector space.
The outlier detector analyses each entity in relation to the centre for each class.

### Feature 7. Representing Complex Classes

A computer implemented method for training a machine learning engine to label sensitive information from text data, the method comprising:
(i) receiving text data and a list of classes that defines the sensitive information to be labelled;
(ii) generating a set of synthetic sentences that contains entities belonging to the one or more classes and using the set of generated sentences for training the machine learning engine;
(iii) predicting labels for entities in a sample of the text data, selecting labelled sentences from the sample of text data to provide to an annotator for reviewing, and updating the training data with the user reviewed sentences; and
(iv) training the machine learning engine with the updated training data and repeating step (iii) until the performance of the machine learning meets an end-user requirement;
and in which the machine learning engine is configured to learn to represent complex classes into multiple sub-classes.

Optional features:
Machine learning engine identifies a complex class by analysing its vector space representation.
Any of the methods above may be applied to train a machine learning engine to de-identify text data.
Any of the methods above may be applied to train a machine learning engine to de-identify text data within image or video-based data.
Any of the methods above may be applied to train machine learning engine to classify any input type within text data that corresponds to the multiple classes.

### Feature 8. Method for Generating a Regex Embedding

A machine learning model built for classifying or identifying sensitive information requires a large amount of labelled data. However there is often little data directly available for identifiers or quasi-identifiers. A solution is provided in which the machine learning engine also includes a regular expression module that automatically generates training data corresponding to a regular expression based on a automata/graph.

We can generalise as:

A computer implemented method for generating a regex embedding for a set of regular expressions, the method comprising:
(i) receiving a list of possible regular expressions, in which each received regular expression can be represented with an automata/graph; and
(ii) expressing all the regular expressions as a combination of common sub-graphs from the possible regular expression graphs.

Optional features:
The method includes the step of generating training data to detect or classify sensitive and/or identifying information within text data.
The regex embedding is used as part of a machine learning engine that is trained to detect or classify sensitive and/or identifying information within text data and is also used in conjunction with traditional, unsupervised learning trained word embeddings.
The regex embedding is provided as an input to a machine learning engine.
The regex embedding is part of a stack embedding that includes conventional word embedding
Step (ii) is learnt from an analysis of the received list of regular expressions.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A computer implemented method for training a machine learning engine to label sensitive information from text data, the method comprising:
(i) receiving text data and a list of classes that defines the sensitive information to be labelled;
(ii) generating a set of synthetic sentences and using the set of synthetic sentences for training the machine learning engine;
(iii) predicting labels for entities in a sample of the text data, selecting a subsample of labelled sentences from the sample of text data to provide to an annotator for reviewing, and updating the training data with the reviewed sentences; and
(iv) training the machine learning engine with the updated training data and repeating step (iii) until the performance of the machine learning engine meets an end-user requirement.

2. The method of claim 1, in which the received text data includes unstructured text data, structured text data or a combination of unstructured and structured text data.

3. The method of claim 1, in which the received text data does not include any annotations or labels.

4. The method of claim 1, in which the method includes the step of providing a confidence score for each labelled sentence or entity, and in which the confidence score is a value that corresponds to the probability or likelihood that the entity belongs to the one or more classes.

5. The method of claim 1, in which each entity is mapped to multiple labels, with a confidence score being associated with each label that has been mapped to the entity.

6. The method of claim 1, in which the method includes the step of outputting the annotated text data.

7. The method of claim 1, in which the end-user requirement includes one or more of the following: a predefined number of iterations reached, a predefined confidence score reached for labelled sentences, a predefined percentage of recall, precision level, class performance or confusion score.

8-9. (canceled)

10. The method of claim 1, in which the sample of text data is selected based on a probability sampling approach, such as a stratified sampling approach.

11. The method of claim 1, in which the synthetic sentences are generated based on grammar rules or models to produce a sequence of words or tokens in context, and in which the grammar rules or models are automatically selected based on analysing the received text data.

12. The method of claim 1, in which the synthetic sentences contain one or more entities that belong to the one or more received classes, and in which the entities that are generated based on a regular expression and/or using lookup lists.

13. The method of claim 1, in which the method includes the step of introducing noise in the synthetic sentences, such as including generating typos.

14-15. (canceled)

16. The method of claim 1, in which the method includes the step of generating a confusion matrix that represents a comparison of the predicted labels with the labels reviewed by the annotator.

17. The method of claim 16, in which the selection of labelled sentences in step (iii) is based on the generated confusion matrix, and in which the method includes the step of providing a confusion score for each labelled entity of the selected sentences, in which the confusion score is a value that indicates how close the prediction for a given class is to the prediction for another class.

18. (canceled)

19. The method of claim 16, in which the confusion score is determined for each selected sentence, based on the confusion score determined for each entity in the sentence.

20. The method of claim 16, in which the machine learning engine is configured to rank each selected sentence based on an analysis of the confusion matrix and/or the confusion scores.

21. The method of claim 16, in which each class or class pair is assigned a weight and in which the labelled sentences provided to the annotator are selected based on the assigned weights.

22. The method of claim 16, in which the confusion matrix and/or the confusion scores are updated for each iteration of step (iii).

23-27. (canceled)

28. The method of claim 16, in which the weights are updated based on the confusion matrix and/or the confusion scores.

29-31. (canceled)

32. The method of claim 1, in which the method includes the step of representing each entity of the selected sentences into a vector space, in which the entities belong to the one or more classes defining the sensitive information to be labelled.

33. The method of claim 1, in which the method includes the step of determining a support for each class, in which the support refers to the set of labelled sentences that contain that class, and in which the method includes the step of representing the support for each class into a vector space and determining a centre within the vector space.

34. (canceled)

35. The method of claim 33, in which an outlier detector is used to detect outliers in the reviewed sentences and in which the outlier detector analyses each entity of the selected sentences in relation to the centre for each class.

36. The method of claim 1, in which the machine learning engine is configured to learn to represent complex classes into multiple sub-classes, and in which the machine learning engine is configured to identify a complex class by analysing its vector space representation.

37-41. (canceled)

42. The method of claim 1, in which the machine learning engine is trained to de-identify text data.

43. The method of claim 1, in which the machine learning engine is trained to de-identify text data within image or video-based data.

44. A computing implemented system configured to train a machine learning engine to label sensitive information from text data, the system comprising:
one or more processors; and
one or more non-transitory computer-readable media that collectively store instructions that, when executed by the one or more processors cause the computing system to perform operations, the operations comprising:
(i) receiving text data and a list of classes that defines the sensitive information to be labelled;
(ii) generating a set of synthetic sentences and using the set of synthetic sentences for training the machine learning engine;
(iii) predicting labels for entities in a sample of the text data, selecting a subsample of labelled sentences from the sample of text data to provide to an annotator for reviewing, and updating the training data with the reviewed sentences; and
(iv) training the machine learning engine with the updated training data and repeating step (iii) until the performance of the machine learning engine meets an end-user requirement.

45-52. (canceled)
